(19) United States
(12) Patent Application Publication
(10) Pub. No.: US 2010/0057338 A1
(43) Pub. Date: Mar. 4, 2010

(54) METHOD AND SYSTEM FOR ROUTE TRACKING

(75) Inventors: Barbara Febonio, Roma (IT); Sandro Piccinini, Roma (IT)

Correspondence Address: Snell & Wilmer L.L.P. (IBM Corp), 600 Anton Blvd, Suite 1400, Costa Mesa, CA, 92626, US

(73) Assignee: INTERNATIONAL BUSINESS MACHINES CORPORATION, Armonk, NY (US)

(21) Appl. No.: 12/204,148

(22) Filed: Sep. 4, 2008

(51) Int. Cl. G01C 21/34; G08G 1/07

(52) U.S. Cl. 701/200

(57) ABSTRACT

The disclosure relates to a method for tracking and routing multiple vehicles by collecting travel route information from a first vehicle by a plurality of collectors, each of the plurality of collectors positioned at a respective location throughout a travel route of the first vehicle; identifying a second vehicle at a first of the plurality of the collectors and directing the second vehicle through the travel route of the first vehicle by identifying the travel route of the first vehicle to the second vehicle at each of the plurality of collectors; compiling travel data from each of the first vehicle and the second vehicle to determine a travel time for the first vehicle and a travel time for the second vehicle, the compiled travel data defining the travel time as a function of a traffic pattern and a traffic light sequence.

### BACKGROUND

1. Field of the Invention

The disclosure generally relates to a method and system for rout tracking. More specifically, the disclosure relates to a method and system for tracking a first vehicle of a multi-vehicle group and directing subsequent vehicles to use the same route as the first vehicle by using geolocation systems.

2. Description of Related Art

Recent years have seen an explosion in the use of global positioning system (GPS) receivers. Conventional GPSs allow the user to determine its current location by communicating with a plurality of satellites. Specifically, a GPS receiver calculates its position by timing the signals sent by the constellation of GPS satellites which travel above the earth. Each satellite continually transmits messages containing: (1) the time the message was sent, (2) a precise orbit for the satellite sending the message, and (3) the general system health and rough orbits of all GPS satellites. The receiver uses the arrival time of each message signal to measure the distance to each satellite thereby establishing its own location. The information is converted to latitude and longitude, or location on a map and is then displayed.

Using GPS receivers, a traveler can enter its starting and destination addresses and determined a travel route. Using the GPS receivers, the traveler can also determine its current location with respect to the starting and the ending points. The location data provided by the GPS receiver is exclusive to the location of the receiver. Thus, a GPS receiver can service only one vehicle at a time. Thus, when multiple vehicles are traveling together, each vehicle must be equipped with an independent GPS receiver to provide routing information.

Alternatively, one vehicle may be equipped with a GPS receiver and the remaining vehicles must follow the GPS-equipped vehicle in order to obtain the travel route. Trailing a GPS-equipped vehicle is not always practical. For example, in a multi-vehicle trip some vehicles will travel slower than others and consequently may lose sight of the GPS-equipped vehicle. Other vehicles may be slowed down by traffic and lose sight of the GPS-equipped vehicle. Moreover, if the vehicle are traveling at different times of the day, following a GPS-equipped vehicle will not be a viable option. Therefore, there is a need for a method and system for route tracking for multi-vehicle trips.

### SUMMARY

In one embodiment, the disclosure relates to a method for tracking and routing multiple vehicles toward a destination, the method comprising identifying a first vehicle; collecting travel route information from the first vehicle by a plurality of collectors, each of the plurality of collectors positioned at a respective location throughout a travel route of the first vehicle; identifying a second vehicle at a first of the plurality of the collectors and determining whether the second vehicle is entitled to the travel route information of the first vehicle; directing the second vehicle through the travel route of the first vehicle by identifying the travel route of the first vehicle to the second vehicle at each of the plurality of collectors.

In another embodiment, the disclosure relates to a method for tracking and routing multiple vehicles toward a destination, the method comprising identifying a first vehicle; collecting travel route information from the first vehicle by a plurality of collectors, each of the plurality of collectors positioned at a respective location throughout a travel route of the first vehicle; identifying a second vehicle at a first of the plurality of the collectors and determining whether the second vehicle is entitled to the travel route information of the first vehicle; directing the second vehicle through the travel route of the first vehicle by identifying the travel route of the first vehicle to the second vehicle at each of the plurality of collectors; compiling travel data from each of the first vehicle and the second vehicle to determine a travel time for the first vehicle and a travel time for the second vehicle, the compiled travel data defining the travel time as a function of a traffic pattern and a traffic light sequence; and changing the traffic light sequence throughout the route to accommodate the traffic pattern of the travel route

### BRIEF DESCRIPTION OF THE DRAWINGS

These and other embodiments of the disclosure will be discussed with reference to the following exemplary and non-limiting illustrations, in which like elements are numbered similarly, and where:

FIG. 1 schematically represents a method for directing multiple vehicles through the same route according to one embodiment of the disclosure;

FIG. 2 schematically represents a method for directing multiple vehicles through the same route according to one embodiment of the disclosure;

FIG. 3 is a flow diagram showing an exemplary implementation of the disclosure; and

FIG. 4 is another flow-diagram of an exemplary embodiment of the disclosure.

### DETAILED DESCRIPTION

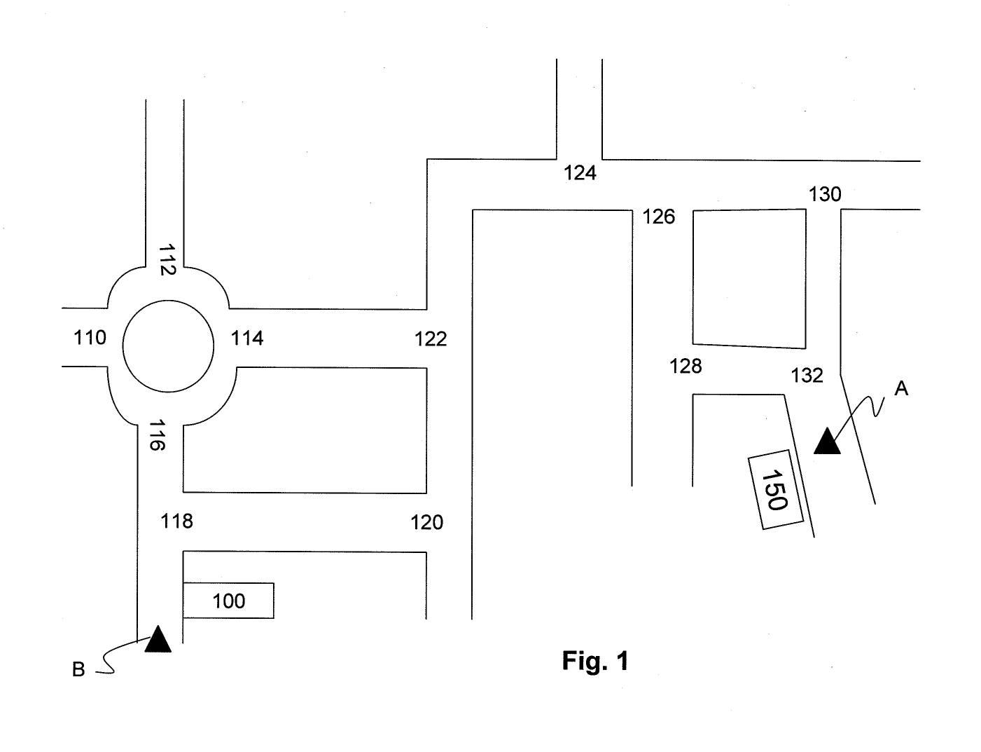

FIG. 1 schematically represents a method for directing multiple vehicles through the same route according to one embodiment of the disclosure. More specifically, FIG. 1 shows the street maps, including buildings 100 and 150 and vehicles A and B. If both vehicles A and B start, at different times, and travel from building 100 to building 150, each vehicle may take one of a number of possible routes. For example, vehicle A may travel through intersections 118, 120, 122, 124, 130 and 132 to reach a destination at building 150. In contrast, vehicle B may travel through intersections 118, 116, 114, 122, 124, 126, 128 and 132 to reach the same destination. If both vehicles travel at the same time, vehicle A can lead the trip and vehicle B may follow. If vehicle B were to lose its line of sight with vehicle A, the former would be lost. While both vehicles can be equipped with GPS systems to guide their path, equipping each and every vehicle with GPS is not always an option. In addition, even with an on-board GPS, vehicle B may not take the same route as vehicle A. Thus, if it is desired to have both vehicles follow the same route, the on-board GPS would not help.

To address this and other deficiencies, in one embodiment of the disclosure each intersection is provided with one or more collector. The collectors can be arranged at the intersections to recognize the vehicle approaching the intersection or traveling through the intersection. For example, the collectors can be placed at one or more traffic lights at each intersection. The collectors can be configured to identify vehicles traveling through the intersection and communicate with each vehicle individually to direct the vehicle's path. In one embodiment of the disclosure, the vehicles are configured to transmit an identification signal which is used by the collectors to identify the vehicle.

The identification signal may include a data signal transmitting the vehicle identification number (VIN). In an exemplary embodiment, each vehicle is equipped with a transponder for transmitting an identification signal. The transponder signal is then collected by one or more collectors within identifiable range of the vehicle. For example, when the vehicle crosses an intersection equipped with four collectors, each of the collectors may identify the vehicle from its transponder signal. Alternatively, each collector may identify the vehicle as the vehicle enters the collector's line of sight or detection range.

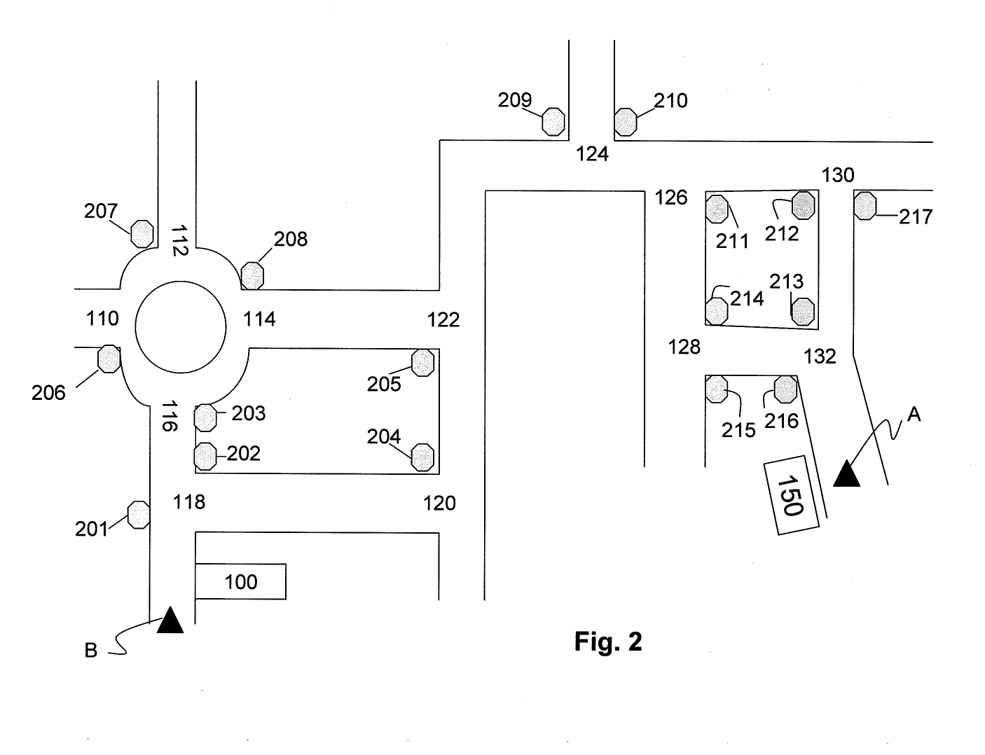

FIG. 2 schematically represent a method for directing multiple vehicles through the same route according to one embodiment of the disclosure. Specifically, FIG. 2 shows collectors 201-216 positioned at various intersections. Each collector can be configured to correspond with a transponder associated with each vehicle. That is, a collector can detect transponder response from a vehicle, identify the vehicle, and direct the vehicle to its destination.

The collectors can communicate with a central control system (not shown). The central control system can gather data from the collectors. The collected data can include, among others, the position of each vehicle, the traffic condition and travel speed at each location.

In an embodiment of the disclosure, the collectors can be programmed to send and receive information to the vehicle transponder. Thus, a collector can communicate with the vehicle by receiving information from the vehicle identifying the vehicle, its travel speed and its location. The collector can also communicate with the vehicle by sending information to the vehicle. For example, the collector can send information to the vehicle regarding road condition ahead. In one embodiment of the disclosure, the collector transmits a signal to the vehicle which is transformed into an audible voice and played on the vehicle's stereo system. In another embodiment, the vehicle's navigation system can be configured to receive data signals from the collector and display the travel direction on a screen viewable to the driver. The navigation system may also be prompted to provide voice command to the driver. In still another embodiment, the collector's signals is received by the vehicle's electronic control unit (ECU) and the driver is alerted to the preferred direction by the ECU's on-board communication system.

In another exemplary embodiment, the collector can also send information to the vehicle regarding the direction the vehicle is supposed to take. Referring to FIG. 2, assume that vehicle A starts a trip at building 100 and concludes the trip at building 150. In traveling from building 100 to building 150, vehicle A travels through intersections 118, 120, 130 and 132. If vehicle B must travel the same route as vehicle A but at a different time, the central control system can be programmed to: (i) record the travel route of vehicle A by identifying the vehicle at each intersection vis-à-vis the corresponding collectors, and (ii) direct vehicle B along the same route as vehicle A using the same collectors.

Thus, collectors 201, 202, 204, 205, 209, 210, 211, 212, 214, 213, 216 can detect the path of vehicle A through their respective intersections. The path of vehicle A can then be charted at the central control system. The central control system can then issue instructions to each of collectors 201, 202, 204, 205, 209, 210, 211, 212, 213, 214, 216 to identify vehicle B as nears the collector and communicate directions to the vehicle. For example, as vehicle B nears collector 201, the collector can signal to the vehicle to turn right at intersection 118. The collector's signal can be in the form of a voice command communicated to the driver of vehicle B through, for example the vehicle's radio or navigation system.

As vehicle B approaches intersection 120, collector 205 identifies the vehicle. Once vehicle B is identified as a vehicle to be directed through a designated path, collector 205 will communicate with vehicle B and direct the vehicle to turn left at intersection 120. Each of collectors 204, 209, 210, 211, 212, 213 and 216 can perform the same steps causing vehicle B to travel through the same path as vehicle A. In this manner, vehicle B will have traveled the identical path as vehicle A without having to follow vehicle A or without using a GPS routing.

In FIG. 2, collectors are positioned at each and every intersection. However, the implementation of the disclosed principles are not limited thereto. Collectors can be placed strategically throughout city streets or highways so that maximum efficiency can be gained from the minimum number of collectors.

As stated, in one embodiment of the disclosure the collectors communicate with a central control system. The collectors can communicate with the central control system wirelessly or through landlines. The collectors can, for example, form a wireless mesh network such as those described under the IEEE 802.16 protocol. In another embodiment, the central control system can wirelessly communicate with the collectors through satellite communication. In a satellite implementation, the central control system can either signal the satellite or define the satellite. The collectors may also be incorporated entirely in the stop lights or traffic signs. In an embodiment where the collectors are integrated with the traffic signals, the central control system may be integrated with the municipality or government organization responsible for controlling traffic lights. In an alternative implementation, the collectors can define a private network deployed and controlled by a private organization.

The information collected by the collectors can be compiled at the central control system for data mining and analysis. For example, the controllers can detect travel speeds and travel patterns across the city at different times and under different conditions. The data can also be used for purposes other than routing vehicles to their destinations. For example, the collected data can be used to sequence the lights throughput the city streets in order to reduce congestion. The data can also be used by the police to locate a vehicle as it travels through town.

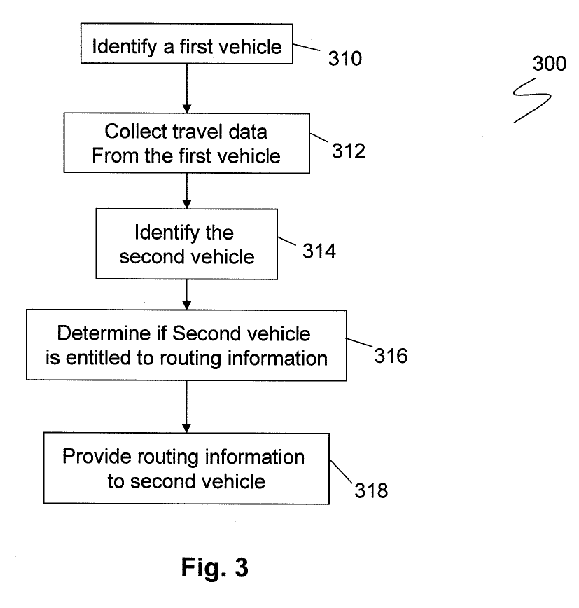

FIG. 3 is a flow diagram showing an exemplary implementation of the disclosure. Flow diagram 300 of FIG. 3 starts with step 310 where one or more collectors identify a first vehicle. The identification can be implemented, for example, by detecting a beacon signal emitted from the vehicle. In step 312, the travel data of the first vehicle is charted. The travel data can be provided by the plurality of collectors each identifying the vehicle in a given timing sequence. Since the location of each collector is known, the first vehicle's route can be charted on the street map.

In step 314 a second vehicle is detected by the collectors. It should be noted that only one collector needs to identify the vehicle or detect its presence before any of the steps shown in FIG. 3 can be implemented. Once the second vehicle is detected at step 314, the central control system determines (step 316) whether the second vehicle is entitled to receive the routing information from the first vehicle. If the second vehicle is entitled to receive routing information from the first vehicle, then one or more collectors along the route will direct the second vehicle to the route taken by the first vehicle (step 318). On the other hand, if the second vehicle is not entitled to routing information, the collectors may passively observe its travel and optionally record its route.

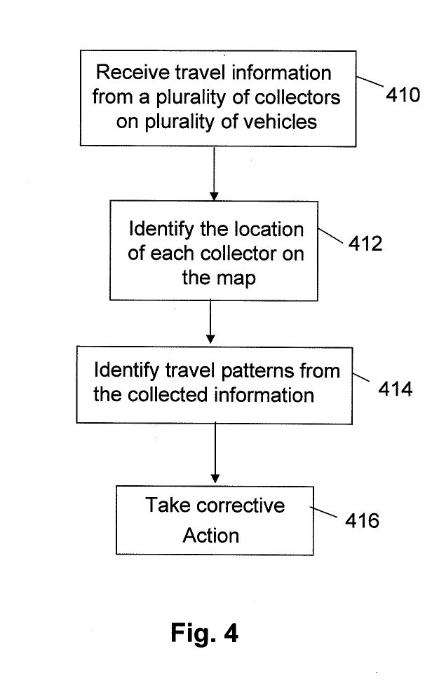

FIG. 4 is another flow-diagram of a an exemplary embodiment of the disclosure. In step 410 of FIG. 4, a plurality of collectors positioned throughout an area collect vehicle travel information from the vehicle in the detection range of the collector. The collected information may include, for example, VIN, travel direction, speed, time of day and date. Additional information such as weather information or road construction can be also be provided by auxiliary systems or by the collectors. The collected information can be forwarded to a central control system where the data is tabulated. In step 412, the location of each collector is identified thereby correlating the collected data with actual locations on the map.

Once the collected data is plotted on the map, one or more travel patterns will emerge as shown in step 414. For example, referring to FIG. 2 the pattern may indicate congestion at intersections 116 and 114 in the mornings and congestion at intersections 110 and 112 in the evenings. In step 416, corrective action is taken based on the information collected by the collectors. The corrective action can have one of many forms. For example, the corrective action may comprise changing the light signal pattern or changing the direction of travel through certain streets.

In still another embodiment, the central control system can monitor and direct travel patterns of several vehicles simultaneously. Thus, a dispatcher can determine the location of several vehicles and direct them remotely to the desired destination. By way of example, the central control system can comprise an ambulance operation. If an emergency situation necessitates one or more ambulances at a location in town, the central control system can determine the location of each of the ambulances and direct the closest ambulance to the scene of the accident. The dispatcher may also determine that several of the ambulances are congregating at the same general location and my direct them to disperse to different sections of the city.

While the principles of the disclosure have been illustrated in relation to the exemplary embodiments shown herein, the principles of the disclosure are not limited thereto and include any modification, variation or permutation thereof.

1. A method for tracking and routing multiple vehicles toward a destination, the method comprising:
identifying a first vehicle having a first driver;
collecting travel route information from the first vehicle by a plurality of collectors, each of the plurality of collectors positioned at a respective location throughout a travel route of the first vehicle;
identifying a second vehicle having a second driver at a first of the plurality of the collectors and determining whether the second vehicle is entitled to the travel route information of the first vehicle;
directing the driver of the second vehicle through the travel route of the first vehicle by identifying the travel route of the first vehicle to the second vehicle at each of the plurality of collectors;
compiling, at a central control system, travel data from each of the first vehicle and the second vehicle to determine a travel time for the first vehicle and a travel time for the second vehicle, the compiled travel data defining the travel time as a function of a traffic pattern and a traffic light sequence; and
changing the traffic light sequence throughout the route to accommodate the traffic pattern of the travel route.
